(19) United States
(12) Patent Application Publication
(10) Pub. No.: US 2015/0367725 A1
(43) Pub. Date: Dec. 24, 2015

(54) MOTOR VEHICLE FUEL TANK WITH VALVE DEVICE MOUNTABLE WITHIN THE SAME

(71) Applicant: Plastic Components and Modules Automotive S.p.A., Torino (IT)

(72) Inventors: Enrico Parola, Borgaro Torinese (Torino) (IT); Pasquale Iacobone, Torino (IT); Etienne Valentin, Torino (IT)

(21) Appl. No.: 14/740,635

(22) Filed: Jun. 16, 2015

(30) Foreign Application Priority Data
Jun. 20, 2014 (IT) TO2014A000498

(51) Int. Cl. B60K 15/03

(52) U.S. Cl. CPC B60K 15/03006; B60K 2015/03026

(57) ABSTRACT

The tank comprises: a hollow body; a valve device (12) received within the hollow body; and a support element (22) adapted to support the valve device (12) and to be fixed to an upper wall (10) of the hollow body. The support element (22) is provided with coupling teeth (30, 32) adapted to engage in respective undercut seats (18, 20) provided in relief portions (14, 16) of the upper wall (10). The coupling teeth (30, 32) comprise a first rigid coupling tooth (30) adapted to engage in a first seat (14) and second elastically deformable coupling teeth (32) adapted to snap engage in respective second seats (16), in such a manner that the first coupling tooth (30), once engaged in the first seat (14), acts as a fulcrum around which the assembly formed by the support element (22) and by the valve device (12) is rotatable and, while rotating, can be urged against the upper wall (10), causing each second coupling tooth (32) to snap engage in the respective second seat (16).

### BACKGROUND OF THE INVENTION

The present invention relates in general to a motor vehicle fuel tank with a valve device mountable within the same, and more particularly to a mounting system for mounting the valve device within the tank.

Present-day standards in the motor vehicle field require that the fuel tank of a motor vehicle meet a number of requirements, including that of being impermeable, or permeable up to a certain maximum admissible level, to petrol vapours. In order to meet this requirement, various methods for manufacturing tanks have been developed and consist in the extrusion blow moulding of a multi-layer material comprising an intermediate layer of EVOH (ethylene vinyl alcohol), acting as a barrier layer, and a pair of outer layers of HDPE (high-density polyethylene).

There is a need not only to limit permeation through the walls of the tank, but also to limit the permeation due to the mounting on the tank of valve devices, such as blocking or vent valves, which are necessary for the correct operation of the fuel supply system. Two different approaches are currently used for this purpose.

The first is based on the positioning and fixing of the valve devices within the tank by engagement of the valve devices, or rather of support elements supporting these devices, with relief portions projecting downwards from the top wall of the tank. This approach is commonly used for the manufacture of tanks for the United States market, where the current standards set maximum permeability limits which are significantly lower than those specified by European standards, for example.

A second approach is that of fixing the valve devices within the tank by means of holes in the top wall of the tank and covering the pierced areas with “patches” of multi-layer material comprising a layer of EVOH. As mentioned above, the present invention relates to the mounting of a valve device within the tank.

A motor vehicle fuel tank with a valve device mountable within the same is known, for example, from EP 0 875 411. According to this known solution, the inside of the tank is provided with a pair of sliding guides, which are formed by the wall of the tank itself and are orientated parallel to one another, for fixing a valve device within the tank, and for this purpose the valve device is provided with a pair of elastically deformable tabs, each of which is adapted to cooperate with a respective sliding guide. The engagement of the elastically deformable tabs of the valve device with the sliding guides of the tank prevents any relative movement of the valve device relative to the tank, except for sliding along the guides. A drawback of this known solution is the free space required to allow the mounting of the valve device, as this free space must be at least equal to the overall dimensions of the valve device in the sliding direction, in order to allow the elastically deformable tabs to be aligned with the sliding guides and thereby allow the elastically deformable tabs to be caused by pushing to slide with the whole valve device along the sliding guides.

A further example of a vehicle fuel tank with a valve device mountable within it is known from EP 1 147 934, which discloses all the features set forth in the preamble of independent claim 1. According to this further known example, the tank comprises a hollow body which forms a relief portion projecting towards the inside of the hollow body and a valve device which is connected to the hollow body by means of an intermediate element including an elastically deformable portion adapted to engage, as a result of its elastic deformation, the relief portion so as to secure the intermediate element, along with the valve device, to the hollow body. The valve device and the intermediate element are configured in such a way that, when the valve device is mounted on the hollow body by means of the intermediate element, the elastically deformable portion of the intermediate element cannot disengage from the relief portion. According to this known solution, the mounting of the valve device within the tank requires the elastically deformable portion to be elastically deformed to enable it to engage the relief portion, and a special tool must be used for this purpose. This makes the operation of mounting the valve device within the tank is not particularly easy. A further drawback of this known solution is that it is impossible to remove the valve device once it has been mounted within the tank.

### SUMMARY OF THE INVENTION

It is therefore an object of the present invention to provide a motor vehicle fuel tank with a valve device mountable within it which is not affected by the aforementioned drawbacks of the prior art.

More specifically, it is an object of the present invention is to provide a motor vehicle fuel tank which allows the valve device to be mounted easily within the tank. A further object of the present invention is to provide a motor vehicle fuel tank which allows the valve device to be removed from the tank, if necessary.

These and other objects are fully achieved according to the invention by means of a motor vehicle fuel tank having the features set forth in the attached claims, the content of which is to be considered as an integral and complementary part of the following description.

In short, the invention is based on the idea of using, for mounting the valve device within the tank, a support element adapted to support the valve device and to be fixed, preferably, in a releasable manner to the upper wall of the tank body, said support element being provided with at least one first rigid coupling tooth adapted to engage in at least one first undercut seat provided in at least one first relief portion formed by the upper wall of the tank body, and with at least one second elastically deformable coupling tooth adapted to snap engage in at least one second undercut seat provided in at least one second relief portion formed by the upper wall of the tank body, on the same side as the valve device with respect to the at least one first relief portion, in such a manner that the at least one first coupling tooth, once engaged in said at least one first undercut seat, acts as a fulcrum around which the assembly formed by the support element and by the valve device can rotate and, while rotating, can be urged against the upper wall of the tank body, causing the at least one second coupling tooth to snap engage in the at least one second undercut seat so as to attach the aforesaid assembly to the upper wall of the tank body.

As will be evident from the following description, the way of fixing the valve device within the tank that is proposed by the present invention makes it possible to overcome the drawbacks of the prior art discussed above, since it does not require any free space around the relief portions to allow the mounting of the valve device, and allows the valve device to be mounted easily within the tank body without requiring the use of a special tool. Furthermore, by suitable shaping of the at least one second coupling tooth and the at least one second undercut seat the valve device can be made removable from the tank, while providing stable and secure fixing in all the operating conditions of the tank.

### BRIEF DESCRIPTION OF THE DRAWINGS

Further features and advantages of the present invention will result more clearly from the following detailed description, which is given purely by way of non-limiting example with reference to the attached drawings, in which:

FIG. 1 is an exploded view showing the mounting of a valve device formed by a single valve within a motor vehicle fuel tank according to an embodiment of the present invention;

FIG. 2 is a perspective view of the assembly formed by the valve, the support element and the locking element of FIG. 1;

FIGS. 3 and 4 are perspective views showing the valve of FIG. 1 in the intermediate position and in the final mounting position within the tank, respectively;

FIG. 5 is a sectional view of the upper wall portion of the tank of FIG. 1, with the valve in the final mounting position, taken through a section plane passing through the rigid coupling tooth of the support element;

FIG. 6 is a sectional view of the upper wall portion of the tank of FIG. 1, with the valve in the final mounting position, taken through a section plane passing through one of the two elastically deformable coupling teeth of the support element;

FIG. 7 is a view similar to that of FIG. 6, in which one of the two elastically deformable coupling teeth of the support element is shown both in the undeformed condition and in a condition in which it is deformed so as to be able to disengage from the respective undercut seat;

FIG. 8 is a perspective view showing a further solution for the mounting of a valve device formed by a single valve within a motor vehicle fuel tank according to the present invention;

FIG. 9 is a perspective view showing the mounting of a valve device formed by a pair of valves within a motor vehicle fuel tank according to the present invention;

FIGS. 10 and 11 are perspective views showing a variant embodiment of the mounting arrangement of FIG. 9;

FIG. 12 is a perspective view showing a further solution for the mounting of a valve device formed by a pair of valves within a motor vehicle fuel tank according to the present invention; and

FIG. 13 is a perspective view of the assembly formed by the two support elements of the embodiment of FIG. 12.

### DETAILED DESCRIPTION OF THE PREFERRED EMBODIMENTS

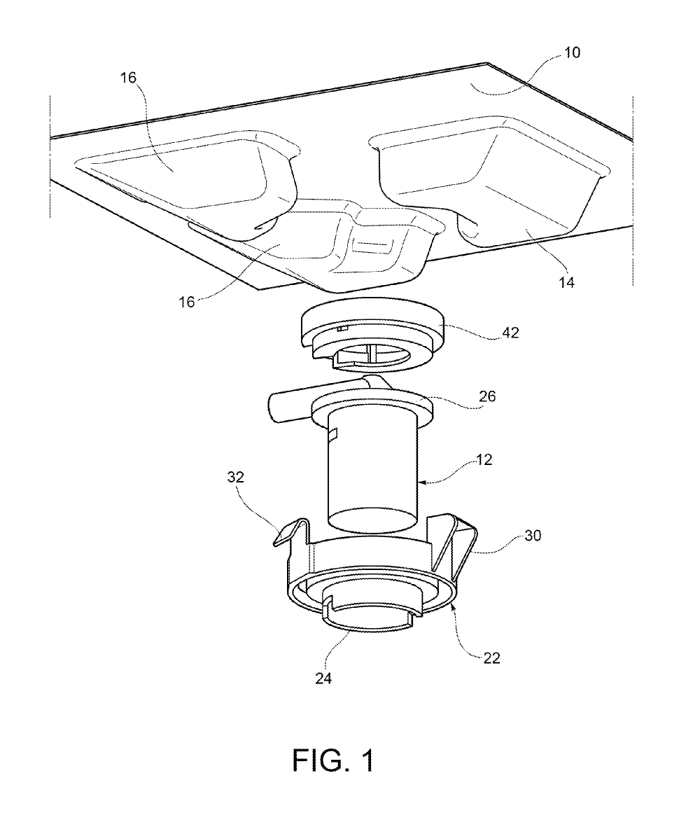

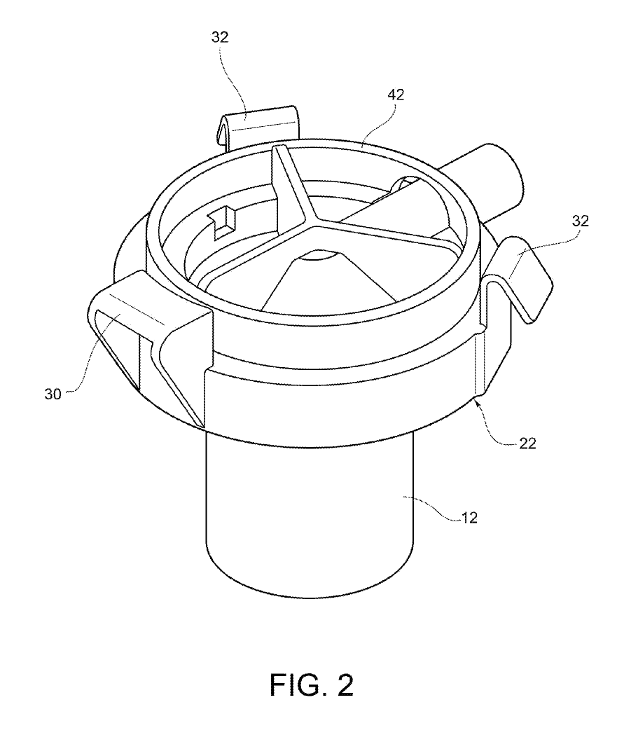

With reference first to FIGS. 1 to 7, a motor vehicle fuel tank according to the invention comprises, in a per-se-known manner, a hollow body (hereinafter simply referred to as “body”), of which only a portion of the upper wall, indicated 10, is shown. The tank body is advantageously made of plastic material by extrusion blow moulding process or by injection moulding or thermoforming process. Within the tank there is mounted a valve device 12, which in the embodiment of FIGS. 1 to 7 is formed by a single valve, for example a so-called roll-over valve (ROV) or a so-called fuel limit vent valve (FLVV). More precisely, the valve device 12 is fixed to the upper wall 10 of the tank body, which for this purpose forms a plurality of relief portions 14 and 16, namely a relief portion 14 having an undercut seat 18 and a pair of relief portions 16, each having an undercut seat 20. In the embodiment shown in FIGS. 1 to 7, the relief portions 14 and 16, with the respective undercut seats 18 and 20, are spaced apart angularly along a circumference centred on a vertical axis of the valve.

To allow the valve device 12 to be fixed to the upper wall 10, the tank is provided with a support element 22 adapted to support the valve device 12 and to be fixed, preferably in a releasable manner, to the upper wall 10 by engagement with the relief portions 14 and 16 formed by this wall. The support element 22 is advantageously made in one piece from plastic material.

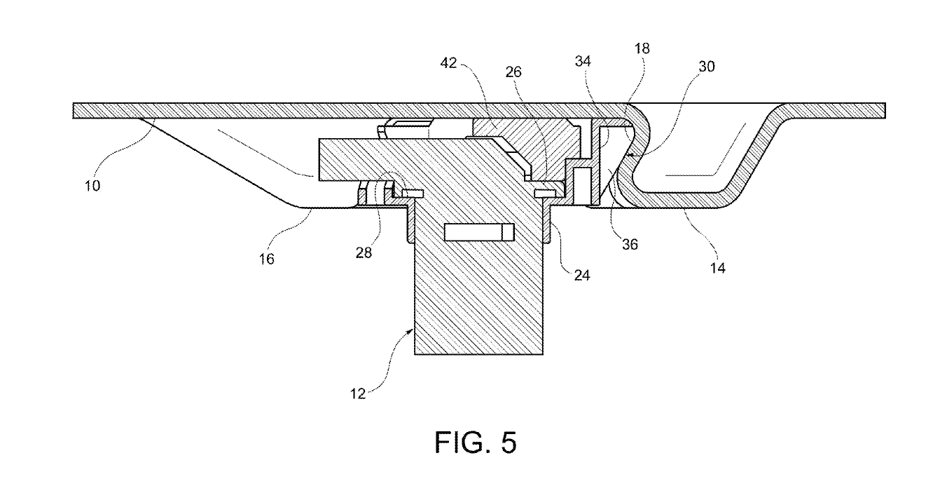

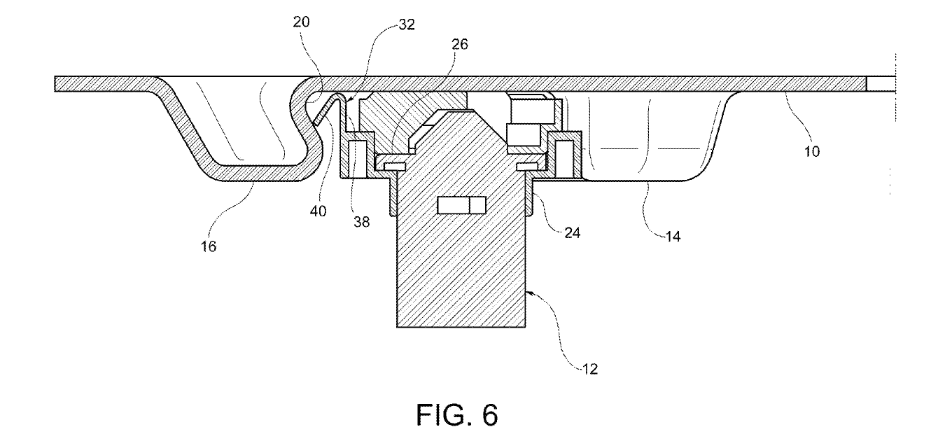

The function of supporting the valve device 10 is obtained, for example, by virtue of the fact that the valve device 12 is inserted and locked into a housing portion 24 of tubular shape formed by the support element 22 and has a flange 26 that bears on an annular support wall 28, coaxial with the housing portion 24, which is also formed by the support element 22, as can be seen in FIGS. 5 and 6.

To allow its fixing, and therefore the fixing of the valve device 12 supported by it, to the upper wall 10, the support element 22 is provided with a rigid coupling tooth 30 adapted to engage in the undercut seat 18 (FIG. 5) and with a pair of elastically deformable coupling teeth 32, each adapted to snap engage in a respective undercut seat 20 (FIG. 6). The coupling teeth 30 and 32 may be made either of plastic material, in which case they are made in one piece with the support element 22, or of metal, in which case they are co-moulded with the plastic material of the support element 22 or are fixed to the support element 22 by other fixing methods of per-se-known type.

In the embodiment proposed herein, the rigid coupling tooth 30 comprises a central portion 34 having a cross section substantially in the shape of an inverted L, and a pair of lateral reinforcing portions 36 fixed to the opposite sides of the central portion 34. Clearly, however, this coupling tooth might have a different shape from that proposed herein, provided that this shape is suitable for making the coupling tooth so rigid that deformation of the coupling tooth is prevented under the loads normally expected during the mounting of the valve device within the tank and during the normal use of the tank.

Each of the two elastically deformable coupling teeth 32 comprises, in the embodiment proposed herein, a support portion 38 extending substantially vertically and a tab 40 connected to the upper end of the support portion 38 and extending outwards and downwards therefrom, forming a given angle (preferably less than 45°) with the support portion 38.

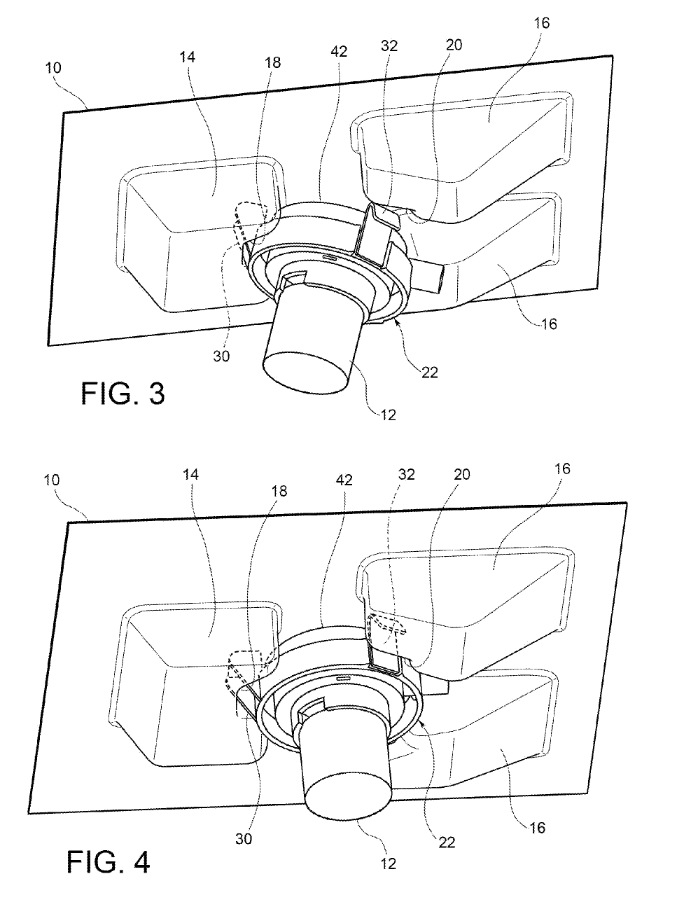

Fixing of the support element 22, together with the valve device 12, to the upper wall 10 of the tank body is essentially carried out in the following two steps, shown in FIGS. 3 and 4, respectively. First (FIG. 3), the rigid coupling tooth 30 is brought into engagement with the respective undercut seat 18. The assembly formed by the support element 22 and the valve device 12 is then pushed against the upper wall 10 of the tank body, rotating around an axis of rotation defined by the contact line between the rigid coupling tooth 30 and the respective undercut seat 18, until the elastically deformable coupling teeth 32 are made to snap engage into the respective undercut seats 20 (as shown in FIG. 4). As will be immediately evident, this operation can be carried out easily by hand by the operator without the use of a special tool.

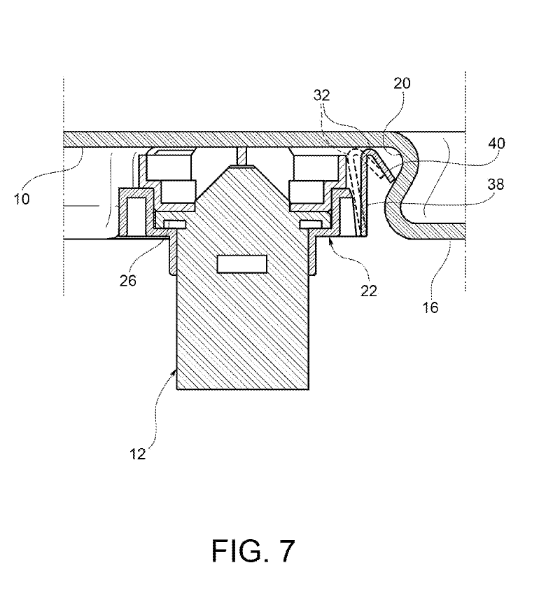

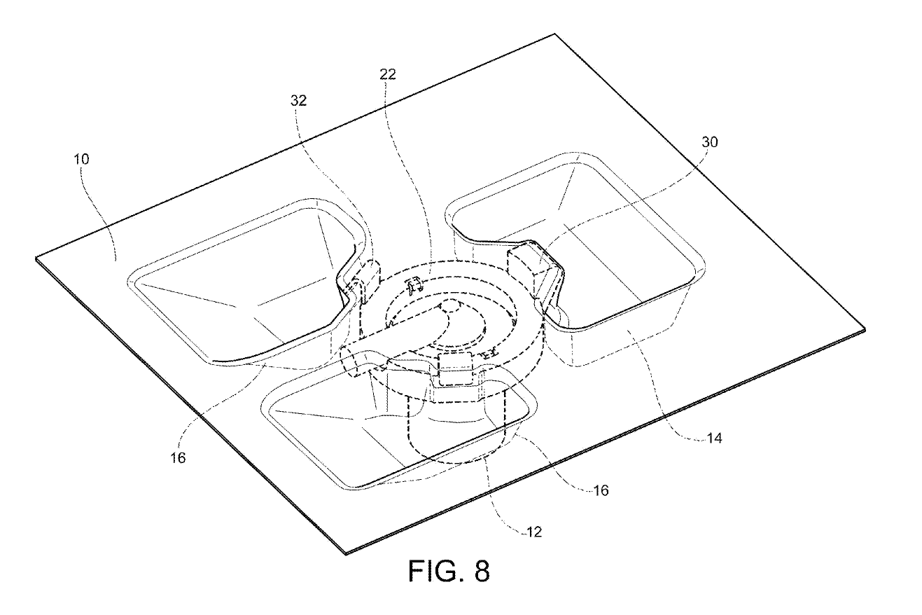

In the embodiment shown in FIGS. 1 to 7, a locking element 42 is also provided, which bears on the top of the flange 26 of the valve device 12 to ensure locking of the valve device 12 on the support element 22. The locking element 42 may also be omitted, as shown in the embodiment of FIG. 8. If it is present, however, the locking element 42 is designed in such a way as to allow, in the condition in which the assembly formed by the support element 22 and the valve device 12 is mounted on the upper wall 10 (as shown in FIG. 7), deformation of the elastically deformable coupling teeth 32 to such an extent that these teeth can disengage from the respective undercut seats 20, and hence the support element 22, together with the valve device 12, can be disconnected from the upper wall 10.

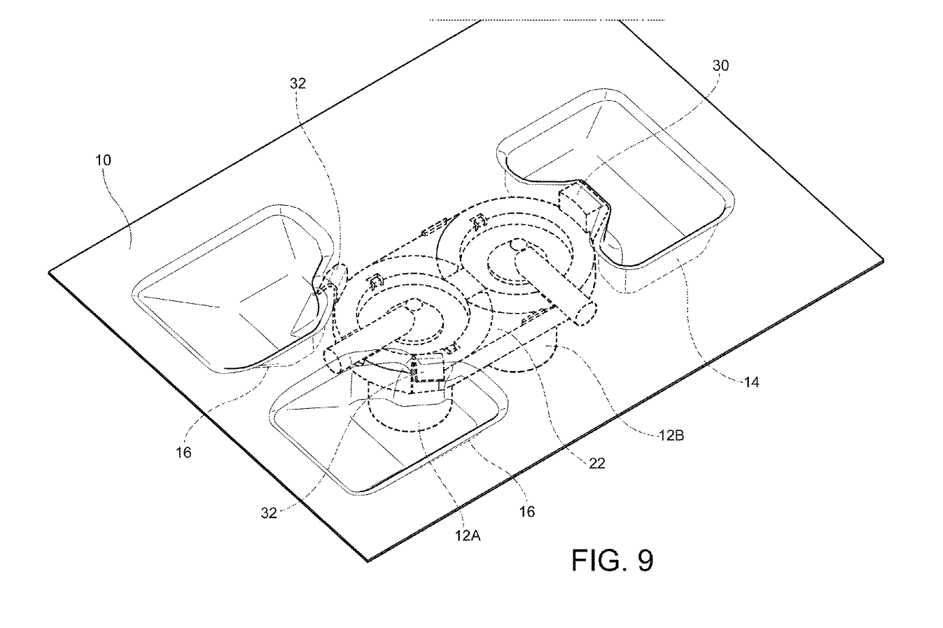

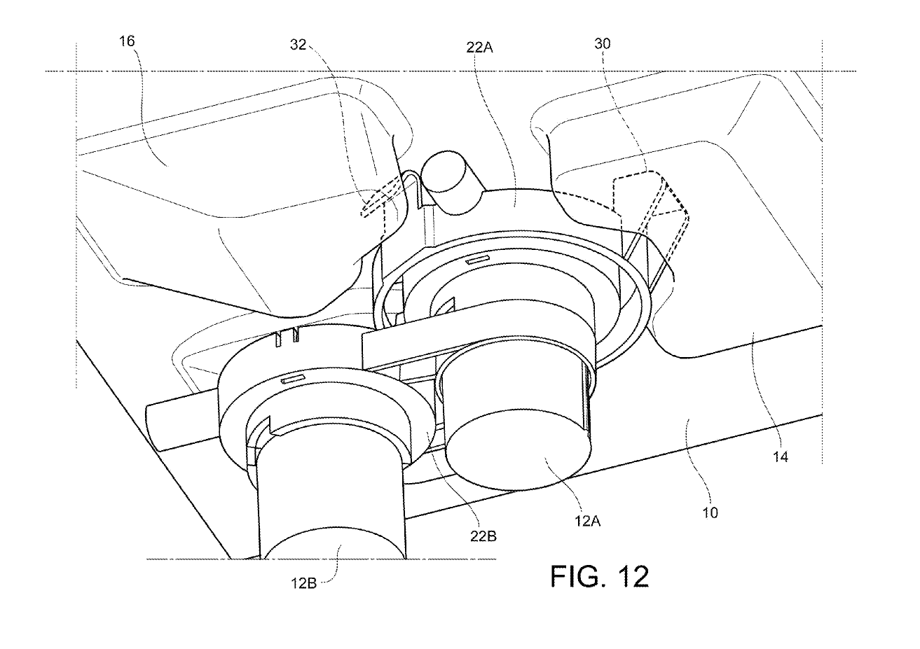

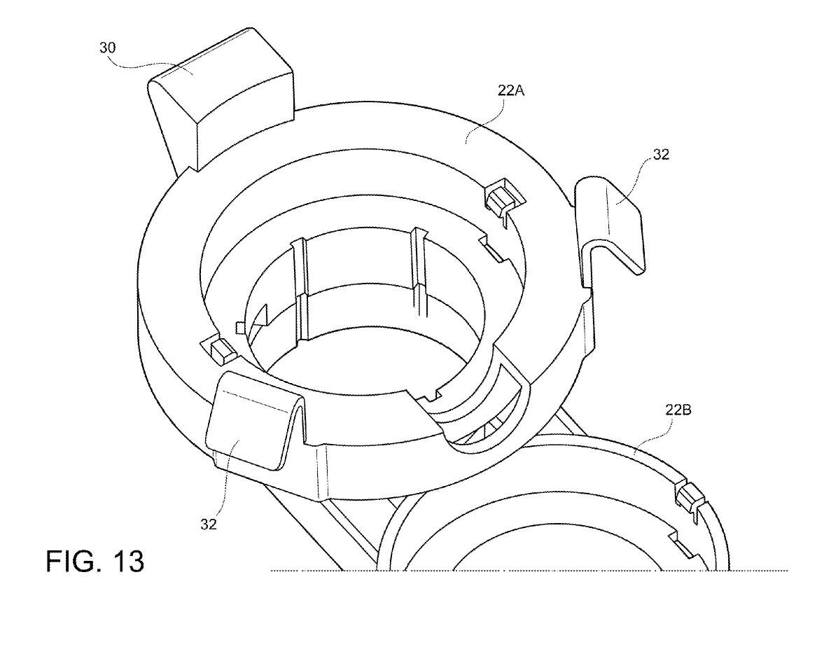

As shown in FIGS. 9 to 13, where parts and elements identical or corresponding to those of FIGS. 1 to 8 have been given the same reference numerals, the invention makes it possible to mount within the tank a valve device 12 made up of two valves, for example an ROV valve and an FLVV valve, which are indicated in the drawings by reference numerals 12A and 12B. In this case, the following two solutions are applicable: using a single support element configured to support both valves (FIGS. 9 to 11) or using an auxiliary support element which is configured to support the second valve and to be fixed to the main support element supporting the first valve, or directly to the first valve itself, and which is adapted to the fixed to the upper wall of the tank (FIGS. 12 and 13).

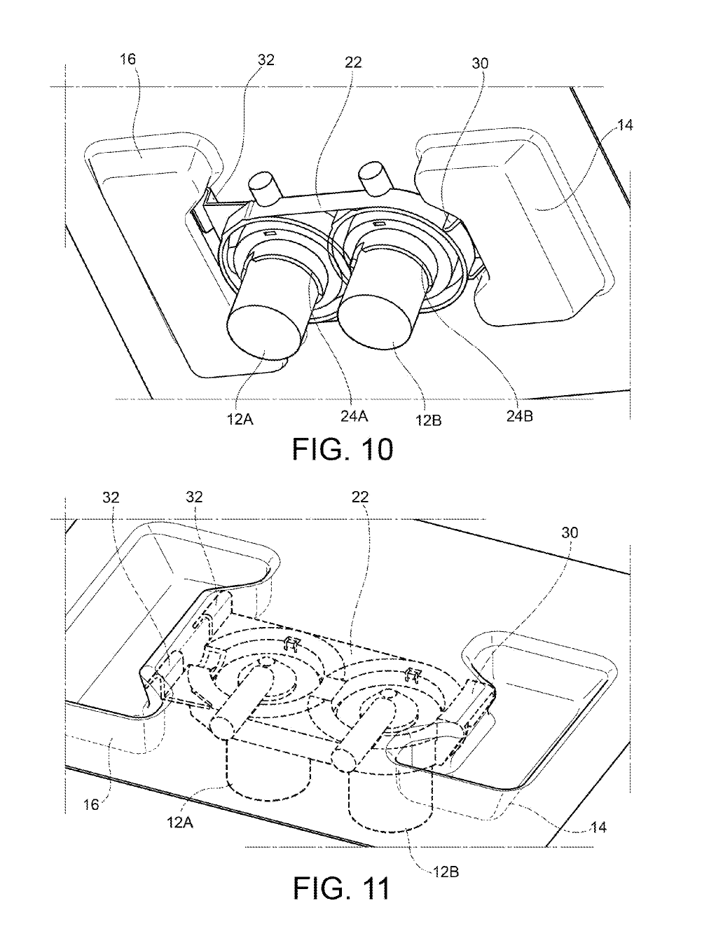

According to the solution shown in FIGS. 9 to 11, the support element 22 forms a pair of housing portions 24A and 24B of tubular shape, into which the first valve 12A and the second valve 12B, respectively, are inserted and locked. The manner in which the support element 22 is fixed to the upper wall 10 of the tank body is similar to that described above with reference to FIGS. 1 to 7. Also in this case, in fact, the support element 22 is provided with a rigid coupling tooth 30 adapted to engage in a first undercut seat 18 provided in a first relief portion 14 formed by the upper wall 10 of the tank, and with a pair of elastically deformable coupling teeth 32, adapted to snap engage in undercut seats 20 provided in relief portions 16 formed by the upper wall 10 of the tank. The undercut seats 20 may be equally well provided either in relief portions 16 separate from one another (as in the embodiment shown in FIG. 9) or in the same relief portion 16 (as in the embodiment shown in FIGS. 10 and 11).

Finally, according to the solution shown in FIGS. 12 and 13 there are provided a first support element 22A (main support element), which supports the first valve 12A and is provided with coupling teeth 30 and 32 for fixing to the upper wall 10 of the tank in a manner similar to that described above with reference for example to the embodiment of FIGS. 1 to 7, and a second support element 22B (auxiliary support element), which supports the second valve 12B and is adapted to be fixed to the main support element 22A or directly to the first valve 12A.

Naturally, the principle of the invention remaining unchanged, the embodiments and details of construction may be varied widely with respect to those described and illustrated purely by way of non-limiting example, without thereby departing from the scope of the invention as defined in the attached claims.

For example, although, in the embodiments described and illustrated herein the rigid coupling tooth of the support element (or of the main support element, where two support elements, one main and one auxiliary, are provided) and the respective undercut seat are shaped so as to form a cylindrical hinge once the tooth is engaged in the seat, the rigid coupling tooth and the respective undercut seat might alternatively be shaped so as to form a spherical hinge in the condition of engagement of the tooth in the seat.

Furthermore, although, in the embodiments described and illustrated herein the support element (or the main support element where two support elements, one main and one auxiliary, are provided) is provided with only one rigid coupling tooth, two or more rigid coupling teeth might alternatively be provided, in which case they would be aligned, as would the respective undercut seats, so as to form a cylindrical hinge. If a plurality of rigid coupling teeth are present, then it would be equally effective to provide in the upper wall of the tank either a plurality of undercut seats, one for each rigid coupling tooth, or a single undercut seat adapted to engage all the rigid coupling teeth of the support element.

What is claimed is:

1. A motor vehicle fuel tank comprising
a hollow body having an upper wall (10) from which relief portions (14, 16) having undercut seats (18, 20) project,
a valve device (12) received within the hollow body, and
a support element (22) adapted to support the valve device (12) and to be fixed to the upper wall (10) of the hollow body, said support element (22) being provided with coupling teeth (30, 32) adapted to engage in said undercut seats (18, 20), wherein the coupling teeth (30, 32) comprise at least one first rigid coupling tooth (30) adapted to engage in at least one first seat (14) of said undercut seats (14, 16) and at least one second elastically deformable coupling tooth (32) adapted to snap engage in at least one second seat (16) of said undercut seats (14, 16), in such a manner that said at least one first coupling tooth (30), once engaged in said at least one first seat (14), acts as a fulcrum around which the assembly formed by the support element (22) and by the valve device (12) is rotatable and, while rotating, can be urged against said upper wall (10), causing said at least one second coupling tooth (32) to snap engage in said at least one second seat (16).

2. Tank according to claim 1, wherein said hollow body is made of plastic material.

3. Tank according to claim 1, wherein said relief portions (14, 16) are integrally formed by said upper wall (10).

4. Tank according to claim 1, wherein the support element (22) is made of plastic material and wherein said at least one first and at least one second coupling tooth (30, 32) are integrally formed by the support element (22).

5. Tank according to claim 1, wherein the support element (22), except for said at least one first and at least one second coupling tooth (30, 32), is made of plastic material, whereas said at least one first and at least one second coupling tooth (30, 32) are made of metal.

6. Tank according to claim 1, wherein the support element (22) is releasably fixed to the upper wall (10) of the hollow body.

7. Tank according to claim 1, further comprising a locking element (42) arranged to lock the valve device (12) against the support element (22).

8. Tank according to claim 7, wherein the locking element (42) is configured to allow an elastic deformation of said at least one second coupling tooth (32) to such an extent as to allow the latter to disengage from said at least one second seat (16).

9. Tank according to claim 1, wherein said valve device (12) comprises first and second valves (12A, 12B) and wherein said first and second valves (12A, 12B) are both directly supported by the support element (22).

10. Tank according to claim 1, wherein said valve device (12) comprises first and second valves (12A, 12B), said first valve (12A) being directly supported by said support element (22A) and said second valve (12B) being directly supported by an auxiliary support element (22B) fixed to said support element (22A) or to said first valve (12A).
